(19) United States
(12) Patent Application Publication
(10) Pub. No.: US 2025/0094790 A1
(43) Pub. Date: Mar. 20, 2025

(54) NEURAL NETWORK TEMPORAL DOMAIN GENERALIZATION METHOD AND SYSTEM

(71) Applicant: Royal Bank of Canada, Toronto (CA)

(72) Inventors: Sepidehsadat HOSSEINI, Vancouver (CA); Mengyao ZHAI, Vancouver (CA); Hossein HAJIMIRSADEGHI, Vancouver (CA); Frederick TUNG, Vancouver (CA)

(21) Appl. No.: 18/891,940

(22) Filed: Sep. 20, 2024

Related U.S. Application Data
(60) Provisional application No. 63/539,497, filed on Sep. 20, 2023.

(51) Int. Cl. G06N 3/049; G06N 3/08

(52) U.S. Cl. CPC G06N 3/049; G06N 3/08

(57) ABSTRACT

Methods, systems, and techniques for neural network temporal domain generalization involve training a backbone neural network using a combination of source domains, determining a domain-specific prompt for each of the source domains while the backbone network is frozen, and sequentially determining i) temporal prompts and ii) a general prompt, while training a temporal prompt generator neural network and keeping the backbone network frozen. The various source domains are indexed temporally and respectively are made of data having a time-dependent distribution shift. The temporal prompts capture the dynamics associated with temporal drift in the data, while the general prompt captures general information across all the source domains. This allows the backbone neural network to be adapted to different time periods.

### CROSS-REFERENCE TO RELATED APPLICATION

The present application claims priority to U.S. provisional patent application No. 63/539,497, filed on Sep. 20, 2023, and entitled “Neural Network Temporal Domain Generalization Method and System”, the entirety of which is hereby incorporated by reference herein.

### TECHNICAL FIELD

The present disclosure is directed at methods, systems, and techniques for neural network temporal domain generalization.

### BACKGROUND

Domain generalization (DG) and adaptation are research fields that have garnered significant attention in recent years due to their practical significance in real-world applications. The primary goal of domain adaptation (DA) is to tailor models to specific target domains, using the similarities that exist between these domains. Continuous domain adaptation, a subset of DA, addresses the adaptation to domains characterized by continuous variables. This may include temporal domain adaptation, which deals with domains that evolve over time. Training loss, for example, may be adapted to account for future data derived from prior domains. Similarly, time-sensitive deep neural network parameters may be used to control their evolution over time. That network possesses domain-specific and domain-generic parameters, with the former integrating an added constraint that considers the similarity between domains. Meanwhile, other approaches focus on learning time-invariant representations using adversarial methods.

DG methods build upon the insights from DA and aim to enhance the generalization capability of models across unseen (target) domains, where the data distribution may differ significantly from the source domain. These methods are useful when adaptation approaches, like domain adaptation (DA), are not feasible due to unavailable target domain data or other possible limitations in adapting the base model.

### SUMMARY

According to a first aspect, there is provided a neural network temporal domain generalization method, the method comprising: for each of multiple source domains respectively corresponding to different times and having a time-dependent distribution shift, determining a domain-specific prompt for the source domain using a backbone neural network and at least one input and at least one output from the source domain, wherein the backbone neural network is trained using a combination of the source domains and is frozen after training, and wherein the domain-specific prompt and the at least one input are input to the backbone neural network and the at least one output is output by the backbone neural network; for each of the source domains, determining a domain-specific prompt for the source domain using the backbone neural network and at least one input and at least one output from the source domain, wherein the domain-specific prompt and the at least one input are input to the backbone neural network and the at least one output is output by the backbone neural network; and sequentially determining for each of the source domains except a first one of the source domains: a temporal prompt for the source domain; and a general prompt common to all of the source domains. The temporal prompt for the source domain and the general prompt may be determined using the backbone neural network, a temporal prompt generator neural network used in respect of all of the source domains, the at least one input and the at least one output from the source domain, and at least the domain-specific prompt of a prior indexed one of the source domains. The temporal prompt may be an output of the temporal prompt generator neural network used in respect of all of the source domains. The temporal prompt generator neural network may be trained during generation of the temporal prompt. Each of the backbone neural network and the temporal prompt generator neural network may comprise a transformer.

The method may further comprise training the backbone neural network using the combination of source domains.

The backbone neural network may be trained to maximize a likelihood [symbol] _{θ}(Y_{1:τ}|X_{1:τ}), in which the backbone neural network is parameterized by θ, and X_{1:τ} and Y_{1:τ} respectively represent inputs and outputs across the source domains.

The domain-specific prompt may be determined by maximizing a likelihood [symbol] _{θ}(Yₜ|[P_{St}; Xₜ]) while the backbone neural network is frozen, in which the backbone neural network is parameterized by θ, P_{St} is the domain-specific prompt, and Xₜ and Yₜ respectively represent inputs and outputs of the source domain specific to the domain-specific prompt.

The general prompt and the temporal prompt may be determined by maximizing a likelihood [symbol] _{θ}(Yₜ|[P_{Tt}; P_{G}; Xₜ]) while the backbone neural network is frozen, in which the backbone neural network is parameterized by θ, P_{Tt} is the temporal prompt for a given one of the source domains, P_{G} is the general prompt, and Xₜ and Yₜ respectively represent inputs and outputs of the given one of the source domains.

The transformer of the temporal prompt generator neural network may comprise a single encoder layer.

The time-dependent distribution shift may be continuous over all of the source domains.

The domain-specific prompt may be prepended or appended to the input when input to the backbone neural network.

The first one of the source domains may correspond to the source domain earliest in time, and the prior indexed one of the source domains may be the source domain that immediately precedes the source domain for which the temporal prompt is being determined. Alternatively, the first one of the source domains may corresponds to the source domain latest in time, and the prior indexed one of the source domains may be the source domain that immediately follows the source domain for which the temporal prompt is being determined.

Determining the temporal prompt for the source domain may comprise keeping frozen all of the temporal prompts for all of the prior indexed ones of the source domains.

The source domains may correspond to non-overlapping periods of time.

The input to the backbone neural network for any one of the source domains during the sequential determining may comprise the at least one input prepended or appended to the general prompt, and the at least one input and the general prompt may be prepended or appended to the temporal prompt.

The domain-specific prompts of all of the prior indexed ones of the source domains may be used during the sequential determining of the temporal prompt for each of the source domains.

The training of the temporal prompt general neural network, and the determining of the temporal prompt for each of the source domains and the general prompt, may be performed by applying backpropagation based on a loss determined using an output of the backbone neural network.

The domain-specific prompts for the source domains may be free parameters.

The method may further comprise determining a target output from a target input, in which the target input and target output comprise part of a target domain that is subsequent to a last of the source domains, and in which determining the target output comprises: determining a target temporal prompt using the domain-specific prompts of the source domains; and inputting the target temporal prompt, the target input, and the general prompt to the backbone neural network.

According to another aspect, there is provided a neural network temporal domain generalization system, the system comprising at least one processing unit configured to perform the foregoing method. The system may further comprise at least one database storing the source domains, which may be used by the system to train the backbone network.

According to another aspect, there is provided at least one non-transitory computer readable medium having stored thereon computer program code that is executable by at least one processor and that, when executed by the at least one processor, causes the at least one processor to perform the foregoing method.

This summary does not necessarily describe the entire scope of all aspects. Other aspects, features and advantages will be apparent to those of ordinary skill in the art upon review of the following description of specific embodiments.

### BRIEF DESCRIPTION OF THE FIGURES

In the accompanying drawings, which illustrate one or more example embodiments:

FIG. 1 is a flowchart depicting a neural network temporal domain generalization method, according to an example embodiment.

FIG. 2 depicts training and testing stages performed during neural network temporal domain generalization, according to an example embodiment.

FIG. 3 depicts a computer system that may be used to implement the method of FIG. 1 and the stages of FIG. 2, according to an example embodiment.

### DETAILED DESCRIPTION

DG methods can be categorized into three groups based on their focus. First, data manipulation methods, which include data augmentation by manipulating input data through domain randomization, adversarial data augmentation, and data generation. Second, representation learning by either applying domain-invariant representation learning techniques or feature disentanglement techniques to improve generalization. Third, learning strategy methods exploit various learning strategies like ensemble learning, meta-learning, and gradient operations to enhance the overall generalization capability.

DG is useful for scenarios where domain adaptation comes short, and models must excel across unseen domains with diverse data distributions. However, most existing DG methods target categorical-indexed domains for categorical tasks. Temporal DG, which addresses the continuous time-evolving distribution shift known as concept drift, is scarcely studied. Standard DG methods are not readily adaptable to temporal DG. Unlike standard DG, which seeks general representations across domains, temporal DG prioritizes capturing domain data's temporal dynamics. The GI method (e.g., [6]) uses adversarial training to generalize over time, altering the leaky ReLU activation for time dependence. However, its adversarial nature limits its efficiency with larger datasets or models. DRAIN [3], a recent temporal DG approach, generates future model weights based on previous domains data but is inefficient in terms of parameters. Generating weights for state-of-the-art network architectures, like transformers, becomes challenging. Most existing works demonstrate efficacy only in classification and regression, neglecting other applications, underscoring the need for a more versatile temporal DG framework.

Prompt-based learning has also gained traction in the field of natural language processing (NLP) for adapting pre-trained language models (PLMs) to various downstream tasks. This framework involves conditioning the model with additional instructions to perform specific tasks. This technique has been particularly successful in few-shot classification tasks like sentiment analysis and natural language inference, where manually designed prompts were employed. However, formulating such a prompting function is challenging and often demands heuristic knowledge. Prompts encapsulate task-specific supervision with notably fewer supplementary parameters than competing techniques.

Machine learning traditionally assumes that training and testing data are distributed independently and identically. However, in many real-world settings, the data distribution can shift over time, leading to poor generalization of trained neural networks in future time periods. The present disclosure presents a prompting-based approach to temporal domain generalization that is parameter-efficient, time-efficient, and does not require access to the target domain data (e.g., unseen future time periods) during training. The disclosed methods, systems, and techniques adapt a target pre-trained neural network to temporal drift by learning global prompts, domain-specific prompts, and drift-aware prompts that capture underlying temporal dynamics. It is compatible across diverse tasks, such as classification, regression, time series forecasting, and natural language processing, and sets a new state-of-the-art benchmark in temporal domain generalization.

Machine learning has achieved great success in many applications in recent years and most machine learning algorithms rely on the assumption that the training (i.e., source) and test (i.e., target) data are independently and identically distributed (i.i.d.). However, distribution shift and concept drift are often observed in reality and these non-i.i.d problems are more computationally challenging to tackle. In DA, extensive research has been conducted on adapting models to the target domain by modelling the domain relations between the source and the target. However, such models assume that target domain data is available, which may not always hold in real-world settings. DG methods tackle the scenario where models are directly generalized to the target domain without the presence of the target data (labelled or unlabeled).

DG traditionally focuses on generalization among categorical-indexed domains with categorical tasks. In contrast, temporal DG addresses the continuously time-evolving distribution shift (namely concept drift) problem. For example, it may be desired to predict house prices given information about the property's physical characteristics, such as square footage, number of bedrooms, number of bathrooms, and location. Since house prices are influenced by macroeconomic conditions and demographic trends that change over time, a regression model trained on data collected from the past few years could have poor predictive power next year. However, if the macroeconomic and demographic factors change gradually over time, it may be possible to extrapolate their influence into the short-term future, and adapt the regression model to make more accurate predictions. This is where temporal domain generalization can be applied. For example, suppose it is known that the population in a particular country has been steadily aging over the past several years, which reduces the overall demand for many-bedroom houses. A temporal DG algorithm can anticipate that the demand will continue to fall for many-bedroom houses and adapt the price predictions for these houses accordingly: given the same features, a many-bedroom house next year will be priced some amount less than this year. Note that in the temporal DG setting, the “test domain”, i.e., next year's house prices, is unknown during training. Therefore, temporal DG methods that model the continuously time-evolving data dynamics and generalize well to the future are needed.

Most standard DG methods cannot be directly applied to temporal DG. Different from standard DG problems which aim at discovering general representations among different domains and learning domain-invariant features, capturing the temporal dynamics of domain data changing over time is performed for temporal DG. Learning domain-invariant features, namely time-invariant representations in temporal DG cases, does not work for temporal DG. Prior methods directed at temporal DG problems are inefficient and hard to be applied to large datasets and large models. Moreover, prior methods have demonstrated effectiveness only for classification or regression tasks, while missing demonstrations on other applications, such as time series forecasting and natural language processing. Therefore, a more efficient temporal DG framework that can enable more diverse tasks is valuable.

Prompting may be applied to efficiently adapting a trained network to different tasks without retraining. Most prior works adopting prompting for DG are applicable to only CLIP [8] and cannot be applied to other architectures or tasks. PADA [4] is a recent work proposed for DG. It first generates example-specific prompts, then the generated prompts are applied to T5 for classification tasks. However, PADA is applicable to only classification tasks and it can only generate word tokens as prompts. Moreover, none of these prior works can generate time-sensitive prompts that capture temporal dynamics.

In contrast, the embodiments described herein are directed at a parameter-efficient and time-efficient prompting-based temporal DG method. To capture temporal dynamics, domain-specific prompts are first generated on each domain, then time-sensitive prompts are learned by modeling the temporal changes from domain-specific prompts and forecasts future prompts for unseen future domains. To learn generic representations, the embodiments described herein also learn global generic prompts that are shared across all domains. The prompts are generated in vector space and can be applied to a wide range of network architectures.

In sum, the present disclosure describes a prompting-based temporal DG method for addressing data distribution shift over time. The disclosed embodiments are parameter-efficient and time-efficient. In contrast to the state-of-the-art approach (e.g., [3]), which generates a full network for each domain including the target domain, only a few parameters shared across all domains are allocated for prompt generation, and no additional parameters are needed for the target domain. At least some of the embodiments herein create domain-specific prompts to capture temporal dynamics and models time-sensitive changes, anticipating prompts for future unseen domains; further, at least some embodiments herein can also be applied to many applications, including classification, regression, time series forecasting, and natural language processing.

### Method

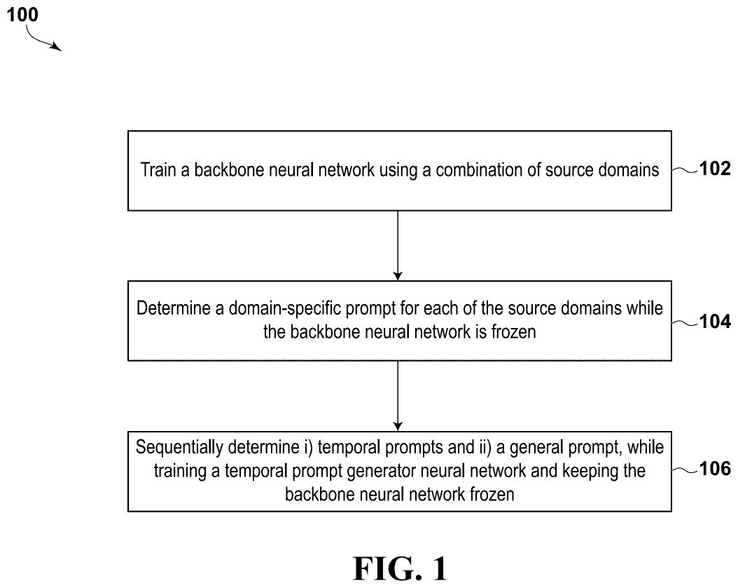

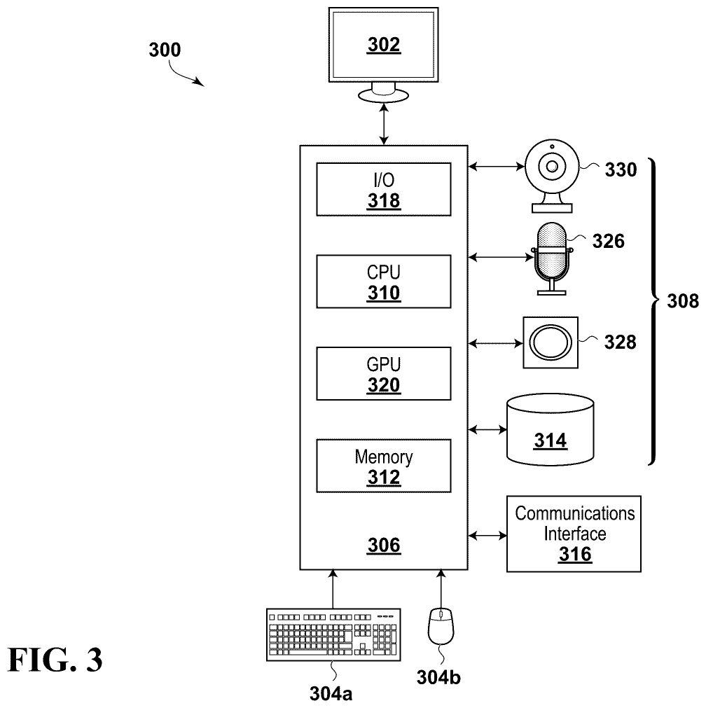

FIG. 1 is a flowchart depicting an example method 100 for neural network temporal domain generalization. The method 100 can be applied to train at least one neural network to perform neural network temporal domain generalization. The method 100 may be expressed as computer program code and stored on at least one non-transitory computer readable medium and executed using at least one processor, such as the memory 312 and CPU 312 of the computer system 300 described in respect of FIG. 3 below.

As described in further detail below, the method 100 comprises the following operations:
1. Training a backbone neural network using a combination of source domains (block 102). A backbone neural network (hereinafter interchangeably a “backbone network”) is trained using a combination of source domains. The source domains respectively correspond to different times and comprise data having a time-dependent distribution shift. Following this initial training, the backbone neural network is frozen for the subsequent operations. While FIG. 1 shows the backbone neural network being trained, in at least some embodiments the backbone neural network may be trained by a third party and then subsequently used as described below in respect of prompt generation.
2. Determining a domain-specific prompt for each of the source domains while the backbone network is frozen (block 104). For each of the source domains, a domain-specific prompt for that source domain is determined using the backbone network and at least one input and at least one output from the source domain. Both the at least one input and the at least one output are known. More particularly, the at least one input and the domain-specific prompt are input to the backbone network, the at least one output is output by the backbone network, and given that the backbone network is frozen the domain-specific prompt may be determined.
3. Sequentially determining i) temporal prompts and ii) a general prompt, while training a temporal prompt generator neural network and keeping the backbone network frozen (block 106). The source domains are indexed temporally. Except for a first one of the source domains, which corresponds either to the source domain comprising the most recent (latest in time) or least recent (earliest in time) data distribution, a temporal prompt for each of the source domains and a general prompt common to all the source domains are sequentially determined. For example, in the case where the first source domain corresponds to the source domain with the oldest data distribution, for the second source domain the temporal prompt specific to the second source domain, and the general prompt, which is common to all the source domains, are determined.
A temporal prompt generator neural network (hereinafter interchangeably referred to as a “temporal prompt generator”) is used to determine the domain-specific temporal prompt from the domain-specific prompt of at least one prior indexed one of the source domains, and in at least some embodiments more than one or all prior indexed ones of the source domains. For example, for the second source domain, the domain-specific prompt of the first source domain may be used; for the third source domain, the domain-specific prompt of the first and second source domains may be used; and so on.
The temporal prompt is an output of the temporal prompt generator, and the same temporal prompt generator is used when determining all of the temporal prompts. In at least some embodiments, the temporal prompt generator is trained (i.e., its biases and parameters are set) while being used to determine temporal prompts across the source domains. Alternatively, the temporal prompt generator may be separately trained. As discussed below, during training the temporal prompt is determined by applying backpropagation and accordingly is also dependent on the backbone network.
For each source domain for which the temporal prompt is determined, the general prompt is determined using the backbone neural network, that temporal prompt, and the at least one input and the at least one output from that source domain in a manner analogous to how the domain-specific prompt is determined at block 104.

More particularly, the method 100 is generally directed at adapting a frozen pre-trained neural network (i.e., the backbone network) to different time periods, under the realistic setting where data distributions evolve over time. While the present example embodiment is directed at using prompts to adapt the frozen backbone network to future time periods, the network may alternatively be adapted to past time periods. Let Dₜ denote a set of temporal domains by [symbol] , where {Dₜ|1≤t≤τ} represents the source domains, and {Dₜ|t>τ} represents the target domains. For example, each temporal domain may contain all data points for one year. Data points from target domains are only observed during test time. The goal is to learn temporal dynamics from source domains that can be directly generalized to future unseen target domains. To accomplish this, the method 100 utilizes three types of learnable prompts: domain-specific prompts, temporal prompts, and a general prompt that is common to all source domains. The domain-specific prompts estimate the distribution [symbol] (Yₜ|Xₜ) for each domain t, where Yₜ are outputs and Xₜ are inputs. The temporal prompts aim to capture the dynamics associated with temporal drift, and are generated using the domain-specific prompts as well as the data. The general prompt aims to capture general information across all source domains.

In respect of pre-training the backbone network, a transformer-based network represented as f_{θ} is used as the backbone. This is discussed in further detail below in respect of experimental results. This backbone network is pre-trained on the combined datasets from all source domains and the goal is to train f_{θ} maximizing the likelihood [symbol] _{θ}(Y_{1:τ}|X_{1:τ}). After pre-training, f_{θ} weights are fixed in all later steps. This corresponds to block 102 of the method 100.

Following block 102, domain-specific prompt generation is performed. The backbone network is pre-trained on data aggregated across all source domains, without considering the differences in the individual domains. Intuitively, the pre-trained network captures “average” or “general” knowledge and can fail to learn details that reflect particular domains. Therefore, prompts are adopted to capture domain-specific information. For each domain t, the input X is prepended with a prompt P_{St}, which are free parameters. The combined result, represented as [P_{St}; X], is then processed by the frozen backbone network (f_{θ}), which has been pretrained across all domains. To optimize prompt P_{St}, training is performed to maximize the likelihood [symbol] _{θ}(Yₜ|[P_{St}; Xₜ]) while freezing the pre-trained model parameters θ. More particularly, the frozen backbone network (f_{θ}) takes the input [P_{St}; Xₜ] and predicts an output Yₜ^{out}. An objective loss function then takes (Yₜ^{out}, Yₜ) to compute the error, and the loss is backpropagated to train P_{St} while the backbone network (f_{θ}) is kept frozen during backpropagation. A suitable loss function depends on the task being performed; for example, when the task is classification a cross entropy loss function may be used, while for regression a root mean square error (RMSE) function may be used.

Learning on each domain independently, domain-specific prompts P_{S1}, P_{S2}, . . . , P_{S(τ)} are derived, effectively condensing domain knowledge into a concise set of parameters. Formally, for an input sequence X, the task specific prompt is represented as P_{S}∈ [symbol] . The domain-specific prompt generation corresponds to block 104 of the method 100.

Following block 104, temporal prompt generation is performed, which captures capture concept drift over time. This is done by employing a temporal prompt generator and encoding the temporal dynamics into temporal prompts. This module takes in domain-specific prompts from source domains as well as the data, and produces future temporal prompts. This approach utilizes a single-layer transformer encoder module, denoted as g_{ω}, as the prompt generator module. In order to incorporate information from preceding domains, sequential training is used. Starting from domain t=2, for each domain t the temporal prompt generator g, receives domain-specific prompts, P_{S1}, P_{S2}, . . . , P_{S(t-1)}, as input tokens. It then uses those prompts to generate temporal prompts P_{T2}, P_{T3}, . . . , P_{T(t)}. Namely, as in Equation (1) below, it generates the temporal prompt P_{T(t)} for domain t from previous domain-specific prompts.

$${P}_{T ( t )} = {g}_{ω} ( {P}_{S 1 : ( t - 1 )} ) , t = 2 , ... , τ + 1 \qquad ( 1 )$$

Moreover, to help capture generic information across all domains, a generic prompt P_{G}∈ [symbol] is learned. For learning the prompts, input X from domain Dₜ is prepended by generic prompt P_{G} and temporal prompt P_{T(t)}∈ [symbol] . The result denoted as [P_{T(t)}; P_{G}; X] is inputted to the frozen backbone network f_{θ} which has been pre-trained on all the combined source domains as described above. Both P_{G} and the temporal prompt generator g_{ω} are trained to maximize the likelihood [symbol] _{θ}(Yₜ|[P_{Tt}; P_{G}; Xₜ]), while keeping the backbone network f_{θ} fixed. More particularly, the frozen backbone network (f_{θ}) takes the input [P_{Tt}; P_{G}; Xₜ] and predicts an output Yₜ^{out}; an objective loss function takes (Yₜ^{out}, Yₜ) to compute the error; and loss is backpropagated to train P_{Tt} and P_{G} while the backbone network (f_{θ}) is frozen. The loss function may be task-dependent. For example, for classification a cross entropy loss function may be used, while for regression an RMSE loss function may be used.

Temporal prompts P_{T2}, P_{T3}, . . . , P_{T(τ+1)} effectively capture temporal drift and help the pre-trained network to adapt to changes in the data distribution over time, and to anticipate future changes by capturing temporal trends. This determination of the P_{G} and P_{T(t)} corresponds to block 106 of the method 100.

The training performed by blocks 102, 104, and 106 is summarized in pseudo-code as Algorithm 1, below.

Algorithm 1 Training Procedure

Require: Source domains {Dₜ|1 ≤ t ≤ τ}, Target domains {Dt|t > τ}

Pre-trained model to adapt ƒ_{θ} parameterozed by θ, Temporal prompt
generator gω parameterized by ω, Labeled data from source
domains D₁,D₂, ... , D_{T}

Ensure: Domain-specific prompts P_{S1},P_{S2}, ... , P_{Sτ}, Temporal prompts

| | |
|---|---|
| | P_{T2},P_{T3}, ... , P_{Tτ+1} Generic prompt P_{G} |
| 1: | procedure DOMAINSPECIFICPROMPTGEN |
| 2: | for each domain Dt in {Dₜ\|1 ≤ t ≤ τ} do |
| 3: | Prepared X with P_{Sτ} |
| 4: | Process combined input [P_{S1};X] using frozen backbone ƒ_{θ} |
| 5: | Train model to maximize likelihood [symbol] θ(Y\|[P_{St};X]) with θ fixed |
| 6: | end for |
| 7: | Return domain-specific prompts P_{S1},P_{S2}, ... , P_{Sτ} |
| 8: | end procedure |
| 9: | procedure TEMPORALPROMPTGEN |
| 10: | Initialize the temporal prompt generator g_{ω} |
| 11: | for each domain Dt in {Dₜ\|2 ≤ T + 1} do |
| 12: | Provide prompts P_{S1},P_{S2}, ... ,P_{S(t-1)} to temporal prompt generator g_{ω} |
| 13: | Generate temporal prompt P_{Tt} |
| 14: | Prepend input X from domain t with P_{G} and P_{Tt} |
| 15: | Process input [P_{Tt};P_{G};X] using frozen backbone ƒ_{θ} |
| 16: | Train model to maximize |
| | likelihood [symbol] θ(Y\|[P_{Tt};P_{G};X]) with θ fixed |
| 17: | end for |
| 18: | end procedure |

While the prompts P_{Sτ}, P_{Tt} and P_{G} directly prepend (e.g., P_{Sτ} being directly prepended to X) or indirectly prepend (e.g., P_{Tτ} being prepended to X via P_{G}) the input X in Algorithm 1, in at least some other embodiments any one or more of the prompts may be directly or indirectly prepended or appended to the input X, or otherwise input to the backbone network or temporal prompt generator in any other suitable fashion.

Testing/inference follows training. During testing, domain-specific prompts P_{S1}, P_{S2}, . . . , P_{S(τ)} along with generic prompt P_{G} are utilized. Namely, when performing inference using data selected from source domain Dₜ where t=τ+1 using input Xₜ, P_{S1}, P_{S2}, . . . , P_{S(τ)} are used to generate temporal prompts P_{T2}, P_{T3}, . . . , P_{T(τ+1)}; and P_{G}, P_{T(τ+1)}, and Xₜ are input to the backbone network to determine Yₜ.

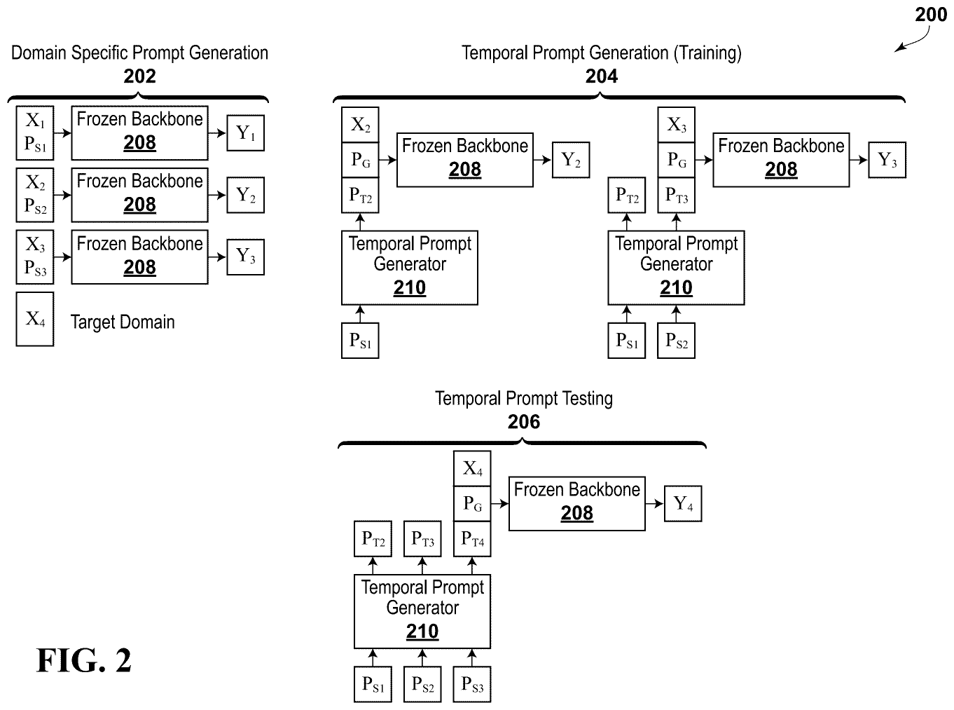

FIG. 2 depicts training and testing of an example neural network temporal domain generalization method consistent with the above. More particularly, elements 202 and 204 respectively directed at domain-specific prompt generation and temporal prompt generation are in respect of training, and element 206 labeled temporal prompt testing is directed at testing/inference.

More specifically, in FIG. 2 given the source domains D₁, D₂, D₃ and the target domain D₄, the backbone network 208 is first trained on the combined source domains (this is not shown in FIG. 2). Then, at element 202, domain-specific prompts P_{S1}, P_{S2}, P_{S3} are generated to learn temporally indexed domain characteristics independently on each source domain while fixing the backbone network 208. At element 204, temporal prompts (P_{T2}, P_{T3}, P_{T4}) are then generated sequentially from domain-specific prompts to capture temporal dynamics. In the example of FIG. 2, any given temporal prompt is the output of the temporal prompt generator 210 when the domain-specific prompts corresponding to all preceding source domains are input. To capture general knowledge across all domains, general prompts P_{G} are also learned at element 204 using [P_{Tt}; P_{G}; Xₜ] as input to the frozen backbone network 208 and Yₜ as output. For inference at element 206, the combination [P_{T4}; P_{G}, X] is fed to the frozen backbone network 208 to perform the task on the target domain D₄.

### Experiments

The Adam™ optimizer is used and the learning rate is consistently set to 1e-4 across all datasets. The system is implemented in PyTorch™ on a workstation powered by a 2.10 GHz Intel Xeon™ Gold 6230 CPU (20 cores) coupled with an NVIDIA RTX 5000™ GPU. For each dataset, hyperparameters are tuned according to the suggestions in [3]. The architecture and other specific details for each dataset's experiments are detailed below.

Slightly different backbone networks 208 for each dataset are used in order to have a more fair comparison with state of the art methods.

For the time series datasets Crypto and Weather, the initial inputs are passed through a linear layer, resulting in 64-dimension embeddings. These embeddings are then processed by a transformer encoder layer. The transformer comprises a single encoder layer with four heads, and hidden layers with dimensionality of 128. Finally, the output is passed through another linear layer to achieve the desired output size. The Mean Squared Error (MSE) loss is used for both datasets.

For the datasets that have been used in DRAIN [3], the initial inputs for Elec2, 2Moons, House, and Appliance are transformed through a linear layer to produce 128-dimensional embeddings, whereas for ONP it is a 32-dimensional embedding. These embeddings are subsequently processed by a transformer encoder layer. Notably, to align closely with the DRAIN paper's structure, the transformer encoder of the presently described embodiment employs just one linear layer in the feed-forward segment, as opposed to the conventional two. The transformer setup involves a single encoder layer with one head. The hidden layers maintain a 128-dimensional structure for all datasets, with the exception of ONP, which is set at 64. Outputs are then channeled through another linear layer to derive the desired size. For regression datasets, the Mean Squared Error (MSE) loss is adopted, and for classification datasets, binary cross-entropy loss is adopted.

Domain-specific prompts are learnable free parameters, whose sizes match the embedding dimensions for each dataset.

A transformer with a single encoder layer and 4 heads is employed as the temporal prompt generator 210. The transformer's hidden layers have a consistent 128-dimensional configuration.

Two time series datasets are used in the experiments: Crypto [1] and Weather [10]; three classification datasets: Rotated Moons (2-Moons) [6], Online News Popularity (ONP) [5], and Electrical Demand (Elec2) [6]; and two regression datasets: House prices dataset (House) [6] and Appliances energy prediction (Appliance) [3].

In case of classification and regression datasets (2-Moons, ONP, Elec2, House, and Appliance) the methodology in [3] was followed in dividing datasets into different domains. The Crypto dataset contains 8 features on historical trades, such as open and close prices, for 14 crypto currencies. The goal was to make 15-step predictions of 15-minute relative future returns (Target) with every step being 1-minute ahead of the previous step. The data spans 2018.1.1 to 2021.9.1. Each month is treated as one domain; 2018, 2019, and 2020 are used for training (36 domains) and the first month of 2021 for validation and the next three months of 2021 for testing; therefore, testing domains are Dₜ₁: [2021.02.01: 2021.2.28], Dₜ₂: [2021.03.01: 2021.02.31], and Dₜ₃: [2021.04.01: 2021.04.30]. The weather dataset is captured throughout 2020 and encompasses 21 variables, including air temperature and air pressure, among others, recorded at 10-minute intervals. For the purposes of the present disclosure, the data was categorized monthly and each month was one domain; the first 11 domains were used for training and the 12^{th} domain for testing.

The method 100 was compared against several state-of-the-art methods including temporal domain generalization methods DRAIN [3] and GI [6], continuous domain adaptation methods CDOT [7] and CIDA [9], and prompting method ATTEMPT [2] to validate the effectiveness of the temporal prompts.

The method 100 was also compared against several baseline methods that do not consider temporal drift such as Vanilla-MLP, which is a MLP-based backbone network of DRAIN and is trained on combining all source domains; and Vanilla-Transformer, which is a transformer-based backbone network of the method 100 and is trained on combining all source domains.

Table 1 summarizes the results of the method 100 when compared to other temporal domain generalization methods. The experiments were conducted 10 times for every method on each dataset and both the mean results and the standard deviation are reported. In most cases, it is observed that temporal prompts contribute to significantly lower errors with the exception of the 2-Moons dataset. For the 2-Moons dataset, the method 100 outperforms the baseline methods but underperforms SOTA methods such as DRAIN [3] and GI [6]. This may be because the backbone network 208 is not as strong as DRAIN offline method, which caused slightly weaker performance of the temporal prompts. Table 2 shows the prediction RMSE×10³ on the Crypto dataset.

TABLE 1
Performance comparison of all methods in terms of miss-classification
error (in %) for classification tasks and mean absolute error (MAE)
for regression tasks (for both, the smaller the better.)

| | Classification (in %) | | | Regression | |
|---|---|---|---|---|---|
| Model | 2-Moons | ONP | Elec2 | House | Appliance |
| Vanilla-MLP | 22.4 ± 4.6 | 33.8 ± 0.6 | 23.0 ± 3.1 | 11.0 ± 0.36 | 10.2 ± 1.1 |
| CDOT | 9.3 ± 1.0 | 34.1 ± 0.0 | 17.8 ± 0.6 | — | — |
| CIDA | 10.8 ± 1.6 | 34.7 ± 0.6 | 14.1 ± 0.2 | 9.7 ± 0.06 | 8.7 ± 0.2 |
| GI | 3.5 ± 1.4 | 36.4 ± 0.8 | 16.9 ± 0.7 | 9.6 ± 0.02 | 8.2 ± 0.6 |
| DRAIN | 3.2 ± 1.2 | 38.3 ± 1.2 | 12.7 ± 0.8 | 9.3 ± 0.14 | 6.4 ± 0.4 |
| Vanilla-Transformer | 25.2 ± 0.9 | 33.6 ± 0.5 | 22.5 ± 0.6 | 11.8 ± 0.3 | 5.6 ± 0.4 |
| ATTEMPT | 21.15 ± 1.1 | 34.10 ± 0.6 | 12.26 ± 0.8 | 9.0 ± 0.4 | 4.9 ± 0.5 |
| Method 100 | 8.1 ± 1.0 | 32.7 ± 0.7 | 10.6 ± 0.9 | 8.9 ± 0.20 | 4.7 ± 0.3 |

Results of comparison methods on all datasets are reported from [3] “—” denotes that the method could not converge on the specific dataset.

TABLE 2
Performance comparison of the method 100 against DRAIN [3] and
ATTEMPT [2] on Crypto dataset in terms of root mean square error ×10³.

| | | | Training | In | | | |
|---|---|---|---|---|---|---|---|
| Input length | Method | #Parameter | time(s) | domain | Dₜ₁ | Dₜ₂ | Dₜ₃ |
| Fixed | DRAIN | 8M | 1634 | 3.96 | 4.27 | 7.03 | 7.24 |
| | [1 linear layer] | | | | | | |
| | DRAIN | 239M | 2520 | 3.82 | 3.90 | 6.75 | 6.89 |
| | [2 linear layers] | | | | | | |
| | DRAIN | 254M | 2827 | 3.60 | 3.61 | 6.69 | 6.69 |
| | [3 linear layers] | | | | | | |
| | Vanilla- | 69k | 239 | 4.00 | 4.42 | 7.19 | 7.43 |
| | Transformer | | | | | | |
| | ATTEMPT | 24K | 445 | 3.57 | 4.03 | 7.22 | 7.45 |
| | ATTEMPT-m | 24K | 447 | 3.54 | 3.79 | 6.96 | 7.35 |
| | Method 100 | 25k | 478 | 3.44 | 3.53 | 6.61 | 6.74 |
| Not-Fixed | DG | 8M | 1634 | 4.97 | 5.22 | 7.78 | 7.98 |
| | [1 Linear layer] | | | | | | |
| | DG | 239M | 2520 | 4.61 | 4.95 | 7.38 | 7.47 |
| | [2 Linear layers] | | | | | | |
| | DG | 254M | 2827 | 3.66 | 3.74 | 6.82 | 7.03 |
| | [3 Linear layers] | | | | | | |
| | Vanilla- | 69k | 239 | 4.08 | 4.44 | 7.28 | 7.55 |
| | Transformer | | | | | | |
| | ATTEMPT | 24K | 445 | 3.85 | 4.29 | 7.51 | 7.75 |
| | ATTEMPT-m | 24K | 445 | 3.79 | 4.12 | 7.16 | 7.43 |
| | Method 100 | 25k | 478 | 3.53 | 3.57 | 6.66 | 6.89 |

Ablation studies were conducted on the Crypto dataset and Elec2 datasets. Table 3 shows the contributions of the two prompting mechanisms (P_{T}, P_{G}) of the method 100. Table 4 is an ablation on embedding and prompt size. It is observed that for the Crypto dataset, embedding/prompting of sizes 64 and 128 provided similar or better performance, and smaller embedding/prompting sizes resulted in a more parameter-efficient network. 64 was selected for a better neural network size and performance tradeoff.

TABLE 3
Ablation study on effect of P_{G}, P_{T}
using Crypto and Elec2 datasets

| Crypto | | | | | Elec2 | | |
|---|---|---|---|---|---|---|---|
| P_{G} | P_{T} | Dₜ₁ | Dₜ₂ | Dₜ₃ | P_{G} | P_{T} | Dₜ |
| ✓ | | 3.57 | 6.66 | 6.84 | ✓ | | 14.9 |
| | ✓ | 3.53 | 6.71 | 6.80 | | ✓ | 14.7 |
| ✓ | ✓ | 3.53 | 6.61 | 6.74 | ✓ | ✓ | 10.6 |

TABLE 4
Ablation study on effect of prompt size using Crypto dataset

| Prompt size/ | Vanilla Transformer | | | Temporal prompting | | |
|---|---|---|---|---|---|---|
| Embedding size | Dₜ₁ | Dₜ₂ | Dₜ₃ | Dₜ₁ | Dₜ₂ | Dₜ₃ |
| 32 | 4.20 | 7.20 | 7.45 | 3.57 | 6.64 | 6.85 |
| 64 | 4.42 | 7.19 | 7.43 | 3.53 | 6.61 | 6.74 |
| 128 | 4.52 | 7.59 | 7.79 | 3.45 | 6.58 | 6.79 |
| 256 | 4.45 | 7.25 | 7.39 | 3.45 | 6.64 | 6.79 |

The efficacy of machine learning often depends on data distribution assumptions, which can be challenged by distribution and concept drifts. The present disclosure is directed at situations in which data distribution evolve temporally. Such temporal drifts emphasize the need for temporal domain generalization (DG). The method 100 introduces a parameter and time-efficient prompting-based temporal DG method, bridging gaps in applicability across tasks like time series forecasting and NLP. This represents a significant stride toward anticipating and adapting models to future domains using previous domains information.

An example computer system in respect of which the method 100 described above may be implemented is presented as a block diagram in FIG. 3. The example computer system is denoted generally by reference numeral 300 and includes a display 302, input devices in the form of keyboard 304a and pointing device 304b, computer 306 and external devices 308. While pointing device 304b is depicted as a mouse, it will be appreciated that other types of pointing device, or a touch screen, may also be used.

The computer 306 may contain one or more processors or microprocessors, such as a central processing unit (CPU) 310. The CPU 310 performs arithmetic calculations and control functions to execute software stored in a non-transitory internal memory 312, preferably random access memory (RAM) and/or read only memory (ROM), and possibly storage 314. The storage 314 is non-transitory may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This storage 314 may be physically internal to the computer 306, or external as shown in FIG. 3, or both. The storage 314 may also comprise a database for storing a set of images as described above. For example, the data for the source domains used in the experiments described above may be stored in such a database and retrieved for use in training.

The one or more processors or microprocessors are examples of suitable processing units. Additionally or alternatively, a suitable processing unit may comprise any one or more of an artificial intelligence accelerator, programmable logic controller, a microcontroller (which comprises both a processing unit and a non-transitory computer readable medium), AI accelerator, or system-on-a-chip (SoC). As an alternative to an implementation that relies on processor-executed computer program code, a hardware-based implementation may be used. For example, other types of processing units such as an application-specific integrated circuit (ASIC), field programmable gate array (FPGA), or other suitable type of hardware implementation may be used as an alternative to or to supplement an implementation that relies primarily on a processor executing computer program code stored on a computer medium.

Any one or more of the methods described above may be implemented as computer program code and stored in the internal memory 312 and/or storage 314 for execution by the one or more processors or microprocessors to effect neural network pre-training, training, or use of a trained network for inference.

The computer system 300 may also include other similar means for allowing computer programs or other instructions to be loaded. Such means can include, for example, a communications interface 316 which allows software and data to be transferred between the computer system 300 and external systems and networks. Examples of communications interface 316 can include a modem, a network interface such as an Ethernet card, a wireless communication interface, or a serial or parallel communications port. Software and data transferred via communications interface 316 are in the form of signals which can be electronic, acoustic, electromagnetic, optical or other signals capable of being received by communications interface 316. Multiple interfaces, of course, can be provided on a single computer system 300.

Input and output to and from the computer 306 is administered by the input/output (I/O) interface 318. This I/O interface 318 administers control of the display 302, keyboard 304a, external devices 308 and other such components of the computer system 300. The computer 306 also includes a graphical processing unit (GPU) 320. The latter may also be used for computational purposes as an adjunct to, or instead of, the CPU 310, for mathematical calculations.

The external devices 308 include a microphone 326, a speaker 328 and a camera 330. Although shown as external devices, they may alternatively be built in as part of the hardware of the computer system 300.

The various components of the computer system 300 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such those parts are not mutually exclusive with each other.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

### REFERENCES

[1] Sercan O Arik, Nathanael C Yoder, and Tomas Pfister. Self-adaptive forecasting for improved deep learning on non-stationary time-series. arXiv preprint arXiv:2202.02403, 2022.
[2] Akari Asai, Mohammadreza Salehi, Matthew E Peters, and Hannaneh Hajishirzi. Attempt: Parameter-efficient multi-task tuning via attentional mixtures of soft prompts. In Proceedings of the 2022 Conference on Empirical Methods in Natural Language Processing, pp. 6655-6672, 2022.
[3] Guangji Bai, Chen Ling, and Liang Zhao. Temporal domain generalization with drift-aware dynamic neural networks. In The Eleventh International Conference on Learning Representations, 2023. URL https://openreview.net/forum?id=sWOsRj4nT1n.
[4] Eyal Ben-David, Nadav Oved, and Roi Reichart. Pada: Example-based prompt learning for on-the-fly adaptation to unseen domains. Transactions of the Association for Computational Linguistics, 10:0 414-433, 2022.
[5] Shai Ben-David, John Blitzer, Koby Crammer, Alex Kulesza, Fernando Pereira, and Jennifer Wortman Vaughan. A theory of learning from different domains. Machine learning, 790 (1):0 151-175, 2010.
[6] Anshul Nasery, Soumyadeep Thakur, Vihari Piratla, Abir De, and Sunita Sarawagi. Training for the future: A simple gradient interpolation loss to generalize along time. Advances in Neural Information Processing Systems, 34, 2021.
[7] Guillermo Ortiz-Jimenez, Mireille El Gheche, Effrosyni Simon, Hermina Petric Maretic, and Pascal Frossard. Cdot: Continuous domain adaptation using optimal transport. arXiv preprint arXiv:1909.11448, 2019.
[8] Alec Radford, Jong Wook Kim, Chris Hallacy, Aditya Ramesh, Gabriel Goh, Sandhini Agarwal, Girish Sastry, Amanda Askell, Pamela Mishkin, Jack Clark, et al. Learning transferable visual models from natural language supervision. In International conference on machine learning, pp. 8748-8763. PMLR, 2021.
[9] Hao Wang, Hao He, and Dina Katabi. Continuously indexed domain adaptation. arXiv preprint arXiv:2007.01807, 2020 a.
[10] Haixu Wu, Jiehui Xu, Jianmin Wang, and Mingsheng Long. Autoformer: Decomposition transformers with Auto-Correlation for long-term series forecasting. In Advances in Neural Information Processing Systems, 2021.

1. A neural network temporal domain generalization method, the method comprising:
(a) for each of multiple source domains respectively corresponding to different times and having a time-dependent distribution shift, determining a domain-specific prompt for the source domain using a backbone neural network and at least one input and at least one output from the source domain, wherein the backbone neural network is trained using a combination of the source domains and is frozen after training, and wherein the domain-specific prompt and the at least one input are input to the backbone neural network and the at least one output is output by the backbone neural network;
(b) for each of the source domains, determining a domain-specific prompt for the source domain using the backbone neural network and at least one input and at least one output from the source domain, wherein the domain-specific prompt and the at least one input are input to the backbone neural network and the at least one output is output by the backbone neural network; and
(c) sequentially determining for each of the source domains except a first one of the source domains:
(i) a temporal prompt for the source domain; and
(ii) a general prompt common to all of the source domains,
wherein the temporal prompt for the source domain and the general prompt are determined using the backbone neural network, a temporal prompt generator neural network used in respect of all of the source domains, the at least one input and the at least one output from the source domain, and at least the domain-specific prompt of a prior indexed one of the source domains,
wherein the temporal prompt is an output of the temporal prompt generator neural network used in respect of all of the source domains,
wherein the temporal prompt generator neural network is trained during generation of the temporal prompt, and
wherein each of the backbone neural network and the temporal prompt generator neural network comprises a transformer.

2. The method of claim 1, further comprising training the backbone neural network using the combination of source domains.

3. The method of claim 2, wherein the backbone neural network is trained to maximize a likelihood [symbol] _{θ}(Y_{1:τ}|X_{1:τ}), wherein the backbone neural network is parameterized by θ, and X_{1:τ} and Y_{1:τ} respectively represent inputs and outputs across the source domains.

4. The method of claim 1, wherein the domain-specific prompt is determined by maximizing a likelihood [symbol] _{θ}(Yₜ|[P_{St}; Xₜ]) while the backbone neural network is frozen, wherein the backbone neural network is parameterized by θ, P_{St} is the domain-specific prompt, and Xₜ and Yₜ respectively represent inputs and outputs of the source domain specific to the domain-specific prompt.

5. The method of claim 1, wherein the general prompt and the temporal prompt are determined by maximizing a likelihood [symbol] _{θ}(Yₜ|[P_{Tt}; P_{G}; Xₜ]) while the backbone neural network is frozen, wherein the backbone neural network is parameterized by θ, P_{Tt} is the temporal prompt for a given one of the source domains, P_{G} is the general prompt, and Xₜ and Yₜ respectively represent inputs and outputs of the given one of the source domains.

6. The method of claim 1, wherein the transformer of the temporal prompt generator neural network comprises a single encoder layer.

7. The method of claim 1, wherein the time-dependent distribution shift is continuous over all of the source domains.

8. The method of claim 1, wherein the domain-specific prompt is prepended or appended to the input when input to the backbone neural network.

9. The method of claim 1, wherein the first one of the source domains corresponds to the source domain earliest in time, and wherein the prior indexed one of the source domains is the source domain that immediately precedes the source domain for which the temporal prompt is being determined.

10. The method of claim 1, wherein the first one of the source domains corresponds to the source domain latest in time, and wherein the prior indexed one of the source domains is the source domain that immediately follows the source domain for which the temporal prompt is being determined.

11. The method of claim 1, wherein determining the temporal prompt for the source domain comprises keeping frozen all of the temporal prompts for all of the prior indexed ones of the source domains.

12. The method of claim 1, wherein the source domains correspond to non-overlapping periods of time.

13. The method of claim 1, wherein an input to the backbone neural network for any one of the source domains during the sequential determining comprises the at least one input prepended or appended to the general prompt, and wherein the at least one input and the general prompt are prepended or appended to the temporal prompt.

14. The method of claim 1, wherein the domain-specific prompts of all of the prior indexed ones of the source domains are used during the sequential determining of the temporal prompt for each of the source domains.

15. The method of claim 14, wherein the training of the temporal prompt generator neural network, and the determining of the temporal prompt for each of the source domains and the general prompt, are performed by applying backpropagation based on a loss determined using an output of the backbone neural network.

16. The method of claim 1, wherein the domain-specific prompts for the source domains are free parameters.

17. The method of claim 1, further comprising determining a target output from a target input, wherein the target input and target output comprise part of a target domain that is subsequent to a last of the source domains, wherein determining the target output comprises:
(a) determining a target temporal prompt using the domain-specific prompts of the source domains; and
(b) inputting the target temporal prompt, the target input, and the general prompt to the backbone neural network.

18. A neural network temporal domain generalization system, the system comprising at least one processing unit configured to perform a method comprising:
(a) for each of multiple source domains respectively corresponding to different times and having a time-dependent distribution shift, determining a domain-specific prompt for the source domain using a backbone neural network and at least one input and at least one output from the source domain, wherein the backbone neural network is trained using a combination of the source domains and is frozen after training, and wherein the domain-specific prompt and the at least one input are input to the backbone neural network and the at least one output is output by the backbone neural network;
(b) for each of the source domains, determining a domain-specific prompt for the source domain using the backbone neural network and at least one input and at least one output from the source domain, wherein the domain-specific prompt and the at least one input are input to the backbone neural network and the at least one output is output by the backbone neural network; and
(c) sequentially determining for each of the source domains except a first one of the source domains:
(i) a temporal prompt for the source domain; and
(ii) a general prompt common to all of the source domains,
wherein the temporal prompt for the source domain and the general prompt are determined using the backbone neural network, a temporal prompt generator neural network used in respect of all of the source domains, the at least one input and the at least one output from the source domain, and at least the domain-specific prompt of a prior indexed one of the source domains,
wherein the temporal prompt is an output of the temporal prompt generator neural network used in respect of all of the source domains,
wherein the temporal prompt generator neural network is trained during generation of the temporal prompt, and
wherein each of the backbone neural network and the temporal prompt generator neural network comprises a transformer.

19. The system of claim 18, further comprising at least one database storing the source domains, and wherein the at least one processing unit is further configured to train the backbone neural network using the combination of source domains.

20. At least one non-transitory computer readable medium having stored thereon computer code that is executable by at least one processor and that, when executed by the at least one processor, performs a method comprising:
(a) for each of multiple source domains respectively corresponding to different times and having a time-dependent distribution shift, determining a domain-specific prompt for the source domain using a backbone neural network and at least one input and at least one output from the source domain, wherein the backbone neural network is trained using a combination of the source domains and is frozen after training, and wherein the domain-specific prompt and the at least one input are input to the backbone neural network and the at least one output is output by the backbone neural network;
(b) for each of the source domains, determining a domain-specific prompt for the source domain using the backbone neural network and at least one input and at least one output from the source domain, wherein the domain-specific prompt and the at least one input are input to the backbone neural network and the at least one output is output by the backbone neural network; and
(c) sequentially determining for each of the source domains except a first one of the source domains:
(i) a temporal prompt for the source domain; and
(ii) a general prompt common to all of the source domains,
wherein the temporal prompt for the source domain and the general prompt are determined using the backbone neural network, a temporal prompt generator neural network used in respect of all of the source domains, the at least one input and the at least one output from the source domain, and at least the domain-specific prompt of a prior indexed one of the source domains,
wherein the temporal prompt is an output of the temporal prompt generator neural network used in respect of all of the source domains,
wherein the temporal prompt generator neural network is trained during generation of the temporal prompt, and
wherein each of the backbone neural network and the temporal prompt generator neural network comprises a transformer.
